(19) United States
(12) Patent Application Publication
(10) Pub. No.: US 2024/0308088 A1
(43) Pub. Date: Sep. 19, 2024

(54) GRIPPER

(71) Applicants: HYUNDAI MOTOR COMPANY, Seoul (KR); KIA CORPORATION, Seoul (KR)

(72) Inventors: Beom Su Kim, Yongin-si (KR); Hyun Seop Lim, Anyang-si (KR); Ju Young Yoon, Suwon-si (KR); Kyu Jung Kim, Seoul (KR); Min Woong Jeung, Seoul (KR); Hyo Joong Kim, Seongnam-si (KR); Seong Taek Hwang, Suwon-si (KR); Ho Jun Kim, Gunpo-si (KR); Dong Jin Hyun, Suwon-si (KR); Dong Hyun Lee, Ansan-si (KR)

(21) Appl. No.: 18/223,677

(22) Filed: Jul. 19, 2023

(30) Foreign Application Priority Data
Mar. 16, 2023 (KR) 10-2023-0034679

(51) Int. Cl. B25J 15/00; B25J 15/02

(52) U.S. Cl. CPC B25J 15/0009; B25J 15/022

(57) ABSTRACT

A gripper includes a base unit and finger units coupled to a protruding direction-side of the base unit. Each of the finger units includes a first link structure coupled to the base unit, a second link structure rotatably coupled to the first link structure, and a third link structure rotatably coupled to both the first link structure and the second link structure, and the second link structure includes a finger tip. When the finger unit is pressed in the protrusion direction, the finger tip is brought closer to the base unit in the protrusion direction by the first link structure. When the finger unit is further pressed in the protrusion direction, the finger tip is rotated to be oriented in a direction opposite to the protruding direction in a state in which the finger tip is oriented in a gripping direction that is a direction perpendicular to the protruding direction.

### CROSS REFERENCE TO RELATED APPLICATIONS

This application claims priority from and the benefit of Korean Patent Application No. 10-2023-0034679, filed on Mar. 16, 2023, which is hereby incorporated by reference for all purposes as if set forth herein.

### TECHNICAL FIELD

Exemplary embodiments relate to a gripper capable of gripping an object.

### BACKGROUND

Adaptive grippers that simulate the motion of gripping an object using a human hand are equipped with finger modules that simulate the motion of human fingers. Such a finger module usually has a joint structure, and the human finger that grips an object is simulated by moving the joint structure.

Meanwhile, according to the related art, each of the finger modules is equipped with an individual power source, such as a motor, so that the finger module is driven. Therefore, according to the related art, a gripper equipped with a plurality of finger modules has a large volume, and thus, it is difficult to achieve a lightweight and compact gripper.

In addition, according to the related art, a gripper is driven in a manner in which an object is gripped by simply controlling the movement of a finger module, and thus, the posture capable of gripping the object is limited.

As an example of a gripper in which a method of gripping an object is limited, there may be provided a gripper that presses and grips various objects as finger modules operates and approaches each other. However, gripping using the finger modules according to the related art is not performed in a manner in which an object is seated on the finger modules and lifted while no external force is applied. Instead, the finger modules press the object inward to grip the same, and thus, a continuous external force is applied to the object. The external force is applied to the object by the finger modules. Therefore, an irregularly shaped material is deformed when an external force is applied thereto, and thus, it is difficult to find an appropriate gripping point. An object having an appearance unsuitable for gripping, even if not an irregularly shaped material, is rotated when an external force is applied by the finger modules. Accordingly, this object may be placed in an unsuitable state for gripping due to a change in contact surface.

### SUMMARY

Exemplary embodiments of the present disclosure provide a gripper provided with a finger unit that has an adaptive mechanism capable of gripping various objects in various environments.

An exemplary embodiment of the present disclosure provides a gripper including a base unit and a plurality of finger units coupled to a protruding direction-side of the base unit. Each of the plurality of finger units includes a first link structure coupled to the base unit, a second link structure rotatably coupled to the first link structure, and a third link structure rotatably coupled to both the first link structure and the second link structure, and the second link structure includes a finger tip. When the finger unit is pressed in the protrusion direction, the finger tip is brought closer to the base unit in the protrusion direction by the first link structure. When the finger unit is further pressed in the protrusion direction, the finger tip is rotated to be oriented in a direction opposite to the protruding direction in a state in which the finger tip is oriented in a gripping direction that is a direction perpendicular to the protruding direction.

### BRIEF DESCRIPTION OF THE FIGURES

The accompanying drawings, which are included to provide a further understanding of the disclosure and are incorporated in and constitute a part of this specification, illustrate embodiments of the disclosure, and together with the description serve to explain the principles of the disclosure.

FIG. 1 is a perspective view of a gripper according to a first exemplary embodiment of the present disclosure.

FIG. 2 is a perspective view of a finger unit according to the first exemplary embodiment of the present disclosure.

FIG. 3 is a side view of the finger unit according to the first exemplary embodiment of the present disclosure.

FIG. 4 is a view conceptually showing a first link structure of the finger unit of FIG. 3.

FIG. 5 is a view conceptually showing a second link structure of the finger unit of FIG. 3.

FIG. 6 is a view conceptually showing a third link structure of the finger unit of FIG. 3.

FIG. 7 is a view in which the link structures of FIGS. 4 to 6 are superposed on the finger unit of FIG. 3.

FIG. 8 is a view showing that the finger unit and the link structures are superposed on each other in a state in which the finger unit according to the first exemplary embodiment of the present disclosure is pressed and a finger tip moves closer to a base unit in a direction opposite to a protruding direction.

FIG. 9 is a view showing that the finger unit and the link structures are superposed on each other in a state in which the finger unit of FIG. 8 is further pressed to rotate the finger tip.

FIG. 10 is a view showing that the finger unit and the link structures are superposed on each other in a state in which the finger unit of FIG. 9 is further pressed to further rotate the finger tip.

FIG. 11 is a view illustrating a state in which a gripper including finger units of FIG. 10 grips an object.

FIG. 12 is a view conceptually showing a first link structure according to a second exemplary embodiment of the present disclosure.

FIG. 13 is a view conceptually showing a first link structure according to a third exemplary embodiment of the present disclosure.

### DETAILED DESCRIPTION

Hereinafter, exemplary embodiments of the present disclosure are described in more detail with reference to the accompanying drawings. When reference numerals are given to elements in each drawing, it should be noted that the same elements are designated by the same reference numerals if possible although they are shown in different drawings. Also, in describing exemplary embodiments of the present disclosure, a detailed description of related known configurations or functions is omitted when it is determined that the understanding of the exemplary embodiments of the present disclosure is hindered by the detailed description.

In describing components of exemplary embodiments of the present disclosure, terms such as first, second, A, B, (a), and (c) may be used. These terms are only used to distinguish one component from other components, and the characteristics, orders, or sequences of the corresponding components are not limited by the terms. When one component is described as being “connected,” “coupled,” or “linked” to another component, this component may be directly connected or linked to another component, but it should be understood that other components may be “connected,” “coupled,” or “linked” between these components.

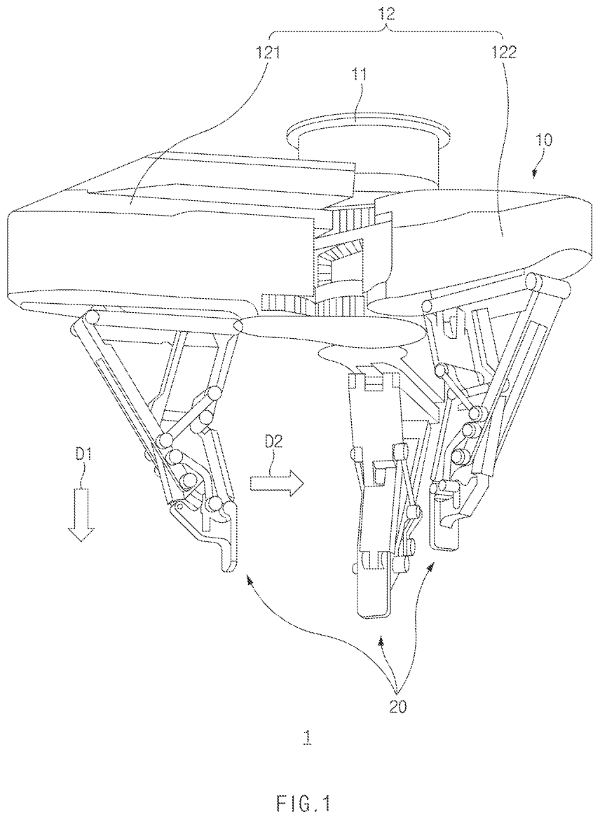

FIG. 1 is a perspective view of a gripper 1 according to a first exemplary embodiment of the present disclosure.

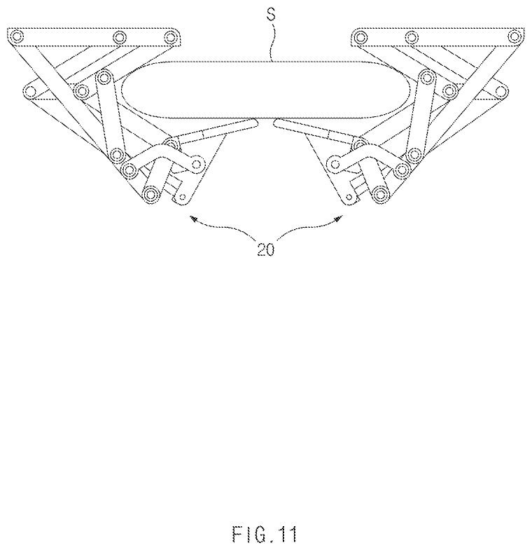

The gripper 1 according to the first exemplary embodiment of the present disclosure may be configured to grip an object S (shown in FIG. 11). More specifically, the gripper 1 according to the present disclosure may be configured to simulate the movement of a human hand to grip the object S. In particular, the gripper 1 according to the present disclosure may have a shape that is flexibly changed depending on the shape of the object S, and the gripper 1 may have a structure capable of variously changing the shape thereof while minimizing the number of driving devices such as motors. Accordingly, it is possible to grip objects S of various sizes and shapes while reducing the weight and size of the gripper 1.

Referring to the drawing, the gripper 1 according to the first exemplary embodiment of the present disclosure includes a base unit 10 and a plurality of finger units 20. The position each of the finger units 20 may be determined by the base unit 10, and the object S may be gripped by detailed operation of each of the finger units 20.

The base unit 10 may include a finger position determination part 12 to which each of the finger units 20 is coupled. The finger position determination part 12 may move each finger unit 20 to determine the position of the finger unit 20. When the gripper 1 is understood as a device that simulates the movement of a human hand, the finger position determination part 12 may be regarded as a component that corresponds to a partial area of a human palm.

The finger position determination part 12 may include a reference base 121 and an operation base 122. Each finger unit 20 may be coupled to either the reference base 121 or the operation base 122 or both the reference base 121 and the operation base 122. The finger units 20 may be coupled to the reference base 121 such that the finger units 20 move relative to the reference base 121 in a direction, in which the reference base 121 extends from a base driving part 11 described below, or in a gripping direction D2 opposite thereto. The finger units 20 may be coupled to the operation base 122 such that the finger units 20 move relative to the operation base 122 in a direction, in which the operation base 122 extends from the base driving part 11, or in the gripping direction D2 opposite thereto. A plurality of operation bases 122 may be provided, and two operation bases may be provided as illustrated in the drawing. However, the number thereof is not limited thereto.

The operation base 122 may move relative to the reference base 121. The base unit 10 may include the base driving part 11. The base driving part 11 is located at the center, and the reference base 121 and the operation base 122 are coupled to the base driving part 11. The power generated by the base driving part 11 is transmitted to the operation base 122, and thus, the operation base 122 may move relative to the reference base 121. As illustrated in the drawing, the operation base 122 may rotate relative to the reference base 121 about a protruding direction D1 as an axial direction. Each of the reference base 121 and the operation base 122 may have a shape extending from the base driving part 11 in a direction crossing the protruding direction D1.

When one of the plurality of finger units 20 moves in the gripping direction D2 or a direction opposite thereto, other finger units 20 may also move a corresponding distance in the gripping direction D2 or the direction opposite thereto. The finger units 20 may be mechanically constrained to each other by the base unit 10 so that the plurality of finger units 20 grip the object S while getting closer to each other or release the gripping while moving away from each other. However, the finger units 20 may be configured mechanically in such a manner that when one finger unit 20 moves in the gripping direction D2, another finger unit 20 moves in the direction opposite to the gripping direction D2.

As used herein, the protruding direction D1 and the gripping direction D2, which cross each other, are relative directions used to describe the shape and operation of the gripper 1. These directions are generally illustrated as downward and left-right directions in the drawings and may vary depending on the direction in which the gripper 1 is oriented. The base driving unit 11 may rotate about the protruding direction D1 as an axial direction, and the gripping direction D2 may represent a direction that is directed inward from each of the finger units 20 to a central axis of the base driving part 11. The protruding direction D1 and the gripping direction D2 may be perpendicular to each other.

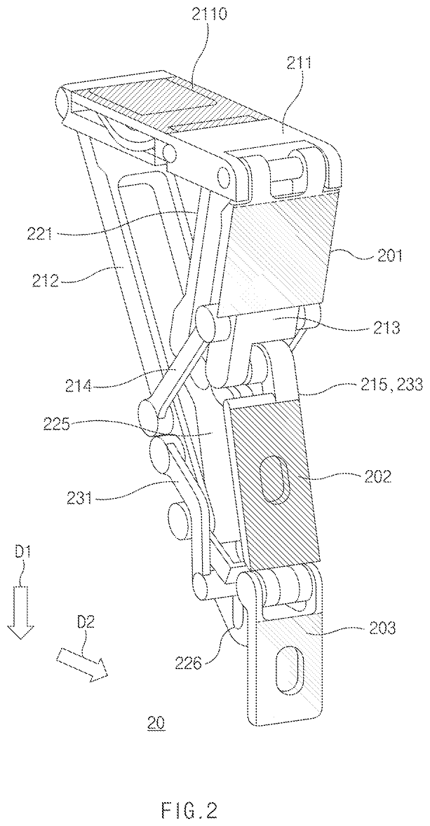

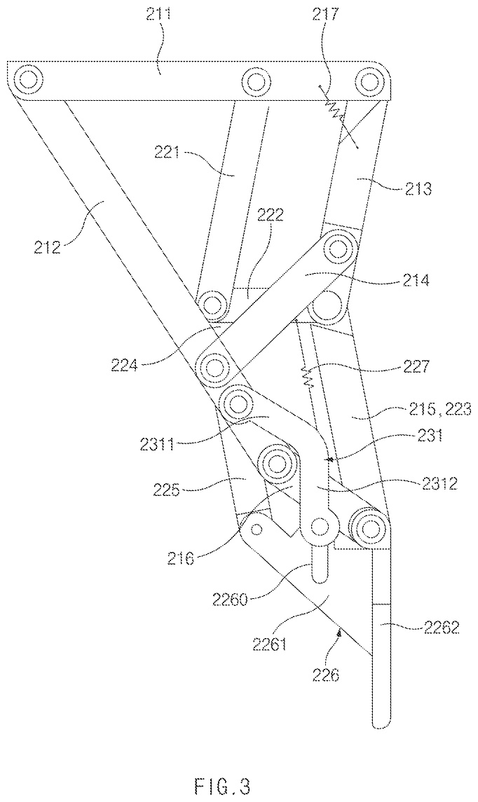

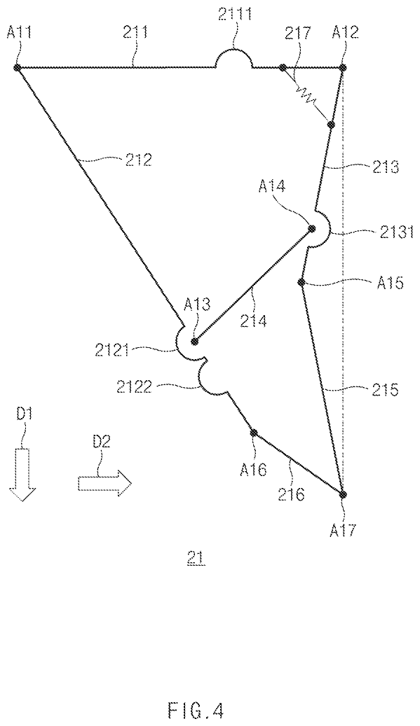

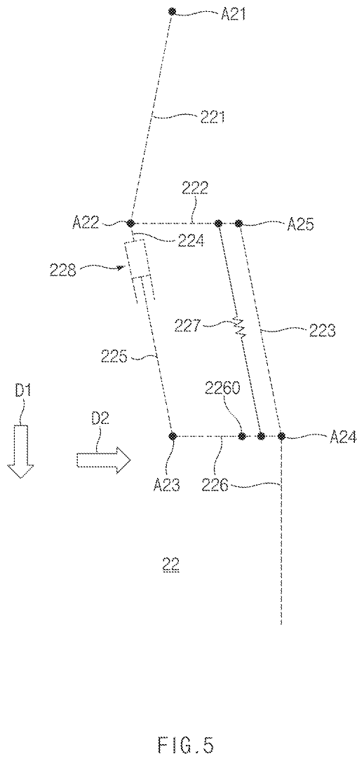

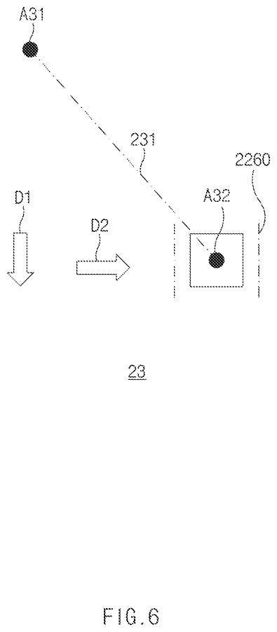

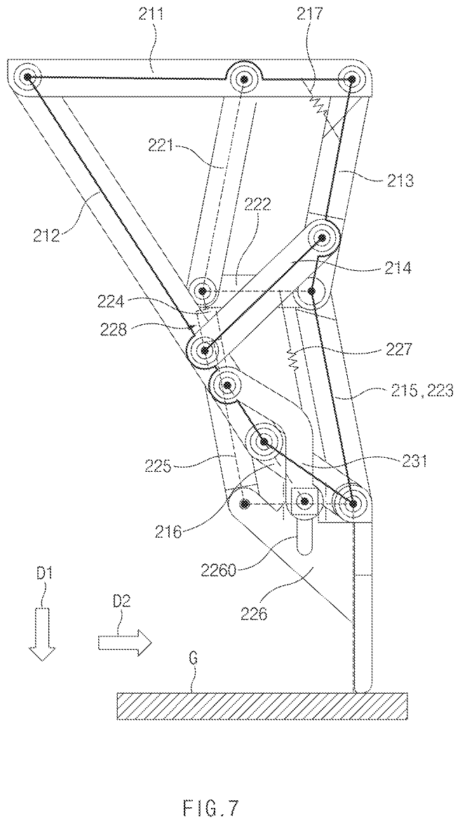

FIG. 2 is a perspective view of a finger unit 20 according to the first exemplary embodiment of the present disclosure. FIG. 3 is a side view of the finger unit 20 according to the first exemplary embodiment of the present disclosure. FIG. 4 is a view conceptually showing a first link structure 21 of the finger unit 20 of FIG. 3. FIG. 5 is a view conceptually showing a second link structure 22 of the finger unit 20 of FIG. 3. FIG. 6 is a view conceptually showing a third link structure 23 of the finger unit 20 of FIG. 3. FIG. 7 is a view in which the link structures 21, 22, and 23 of FIGS. 4 to 6 are superposed on the finger unit 20 of FIG. 3.

The finger units 20 may be configured to simulate the movement of human fingers. As the finger units 20 are pressed, the shapes thereof may be deformed to grip the object S. Referring to the drawings, each of the finger units 20 according to the present disclosure includes the first link structure 21, the second link structure 22, and the third link structure 23. The state shown in FIGS. 3 to 7 is referred to as a first state.

The first link structure 21 is coupled to the base unit 10. The second link structure 22 is rotatably coupled to the first link structure 21. The third link structure 23 is rotatably coupled to both the first link structure 21 and the second link structure 22.

In order to grip the object S, a separate pad part may be located on the inner surface of the finger unit 20 with respect to the gripping direction D2. The pad part may include pads 201, 202, and 203, and each of the pads 201, 202, and 203 is made of a material having elasticity or a material capable of cushioning. Accordingly, an object in contact with the finger units 20 may be easily gripped. The pad part may include an upper pad 201 which is coupled to the inner surface of the first-third link described below. The pad part may include a middle pad 202 which is coupled to the inner surface of the first-fifth link described below. The pad part may include a lower pad 203 which is coupled to the inner surface of a finger tip 226 described below.

Referring to FIG. 4, the first link structure 21 may include a first-first link 211. The first-first link 211 may be coupled and fixed to the base unit 10. The first-first link 211 may have a shape extending in the gripping direction D2. A first-first rotation accommodation portion 2111, to which a second-first link 221 described below is rotatably coupled, may be formed in the first-first link 211. A finger coupling portion 2110, which is detachably coupled to the base unit 10, may be formed on an opposite side of the first-first link 211 in the protruding direction D1.

The first link structure 21 may include a first link module coupled to the first-first link 211 to be rotatable about each of a first-first rotation axis A11 and a first-second rotation axis A12.

The first link structure 21 may include a first elastic member 217 of which one side is coupled to the first-first link 211 and the other side is coupled to the first link module. The first elastic member 217 may be configured to restore the first link structure 21 to the original shape thereof when an external force acting on the first link structure 21 is removed. More specifically, the first elastic member 217 may apply a restoring force to the first link module in a direction in which a link tip of the first link structure 21 coupled to the finger tip 226 moves away from the first-first link 211. This may be understood as that the first elastic member 217 applies the restoring force to the first link module in a direction in which the first link structure 21 is entirely spread. The first elastic member 217 may be made of a material having elasticity. The first elastic member 217 may include a spring, but the first elastic member 217 is not limited thereto as long as an element thereof has elasticity.

The first link module may include a first-second link 212 coupled to the first-first link 211 to be rotatable about the first-first rotation axis A11 and a first-third link 213 coupled to the first-first link 211 to be rotatable about the first-second rotation axis A12. Here, the other side of the first elastic member 217 may be coupled to the first-third link 213. On the basis of a state of FIG. 3, the first-second link 212 may be arranged at an inclination in the gripping direction D2 relative to the protruding direction D1.

A first-second-first rotation accommodation portion 2121, to which a first-fourth link 214 described below is rotatably coupled, may be formed in the first-second link 212. A first-second-second rotation accommodation portion 2122, to which a third-first link 2311 described below is rotatably coupled, may be formed in the first-second link 212.

A first-third rotation accommodation portion 2131, to which the first-fourth link 214 is rotatably coupled, may be formed in the first-third link 213.

The first link module may include a first-fourth link 214 which is coupled to the first-second link 212 to be rotatable about a first-third rotation axis A13 and is coupled to the first-third link 213 to be rotatable about a first-fourth rotation axis A14; and a first-fifth link 215 coupled to the first-third link 213 to be rotatable about a first-fifth rotation axis A15. In the first exemplary embodiment of the present disclosure, it is illustrated that the first-fifth link 215 and a second-third link 223 are integrated with each other, but these links may be formed as separate components and move together as a single body.

Here, the distance between the first-second rotation axis A12 and the first-fourth rotation axis A14 may be less than the distance between the first-second rotation axis A12 and the first-fifth rotation axis A15.

The first link module may further include a first-sixth link 216 which is coupled to the first-second link 212 to be rotatable about a first-sixth rotation axis A16 and is coupled to the first-fifth link 215 to be rotatable about a first-seventh rotation axis A17. Here, the link tip, to which the finger tip 226 is rotatably coupled, may be formed at the first-seventh rotation axis A17. That is, the first-seventh rotation axis A17 may move along a straight line that extends in the protruding direction D1 as indicated by a dotted line in FIG. 4. In other words, points, at which the link tip is located, may be arranged on the straight line. Based on a state of FIG. 3, the first-sixth link 216 may be arranged at an inclination in the gripping direction D2 relative to the protruding direction D1, and the degree of inclination thereof may be greater than the degree of inclination of the first-second link 212.

The distance between the first-first rotation axis A11 and the first-third rotation axis A13 may be less than the distance between the first-first rotation axis A11 and the first-sixth rotation axis A16.

The first link structure 21 may be configured such that a virtual line extending from the first-second rotation axis A12 to the first-seventh rotation axis A17 is always perpendicular to the gripping direction D2 that is a longitudinal direction of the first-first link 211.

In a state in which an external force is removed, the first-third link 213 and the first-fifth link 215 may form a certain angle therebetween. That is, the first link structure 21 may have a shape in which a region, in which the first-third link 213 and the first-fifth link 215 meet each other, is recessed from the virtual line, which connects the first-second rotation axis A12 to the first-seventh rotation axis A17, toward the first-fourth link 214, that is, in a direction opposite to the gripping direction D2. Also, the first link structure 21 may have a shape in which the first-fourth rotation axis A14 and the first-fifth rotation axis A15 are biased toward the first-fourth link 214 from the virtual line that connects the first-second rotation axis A12 to the first-seventh rotation axis A17. This may be understood as that the first link structure 21 includes a triangular region having an approximately triangular shape in a state in which the external force is removed. Also, one side formed by the first-third link 213 and the first-fifth link 215 in the triangular region has an inwardly recessed shape.

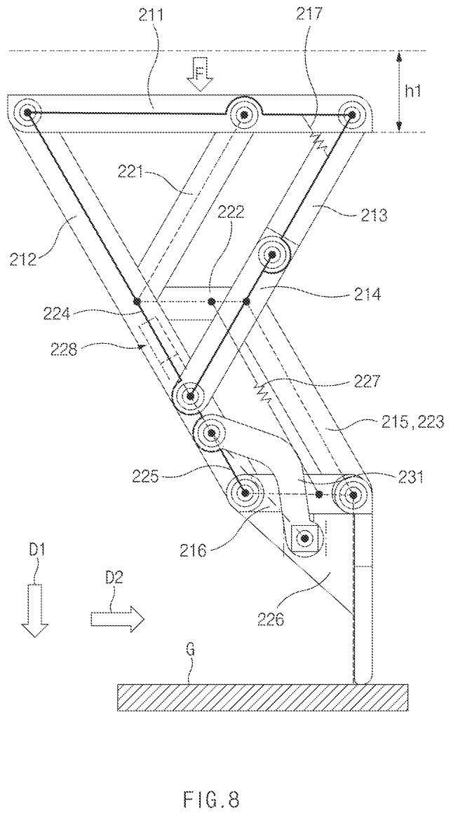

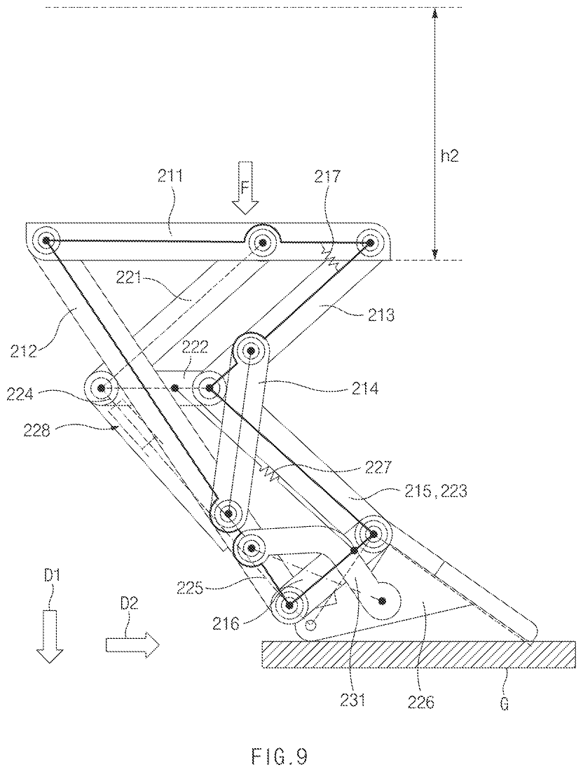

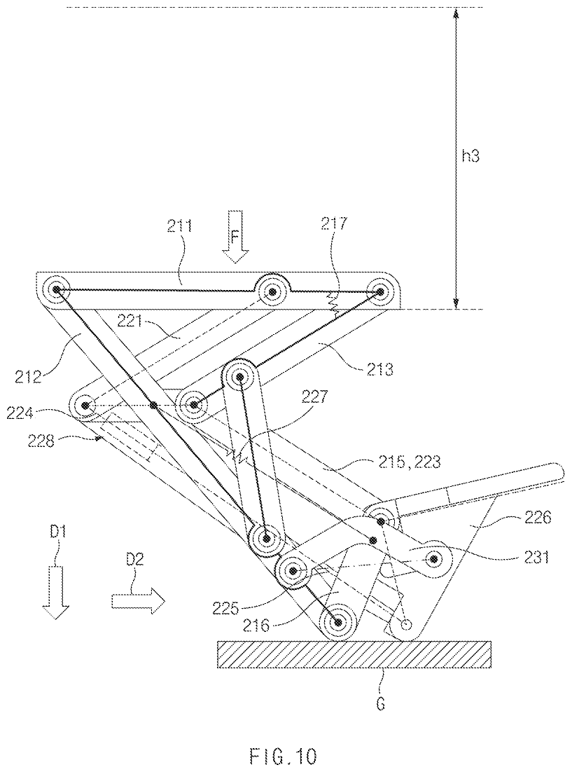

The second link structure 22 includes the finger tip 226. When the finger unit 20 is pressed in the protrusion direction D1 as illustrated in FIG. 8, the finger tip 226 is brought closer to the base unit 10 in the protrusion direction D1 by the first link structure 21. Also, when the finger unit 20 is further pressed in the protrusion direction D1 as illustrated in FIGS. 9 and 10, the finger tip 226 is rotated to be oriented in a direction opposite to the protruding direction D1 in a state in which the finger tip 226 is oriented in the gripping direction D2. When the finger unit 20 is pressed in the protruding direction D1, the base unit 10 moves in the protruding direction D1 in a state in which an end of the finger unit 20 in the protruding direction D1 is in contact with a ground G or the like. Here, the opposite end of the finger unit 20 in the protruding direction D1 may be pressed in the protruding direction D1, and the end of the finger unit 20 in the protruding direction D1 may be pressed in the direction opposite to the protruding direction D1. However, a situation, in which the finger unit 20 is pressed, is not limited thereto.

Referring to FIG. 5, the second link structure 22 may include a second-first link 221 coupled to the first-first link 211 of the first link structure 21 to be rotatable about a second-first rotation axis A21. On the basis of a state of FIG. 3, the second-first link 221 may be arranged at an inclination in a direction opposite to the gripping direction D2 relative to the protruding direction D1.

The second link structure 22 may include a second link module which is coupled to the second-first link 221 to be rotatable about a second-second rotation axis A22 and is rotatably coupled to the finger tip 226. The second link module may be coupled to the finger tip 226 to be rotatable about both a second-third rotation axis A23 and a second-fourth rotation axis A24.

The second link structure 22 may include a second elastic member 227 of which one side is coupled to the second link module and the other side is coupled to the finger tip 226. The second elastic member 227 may be configured to restore the second link structure 22 to the original shape thereof when an external force acting on the second link structure 22 is removed.

More specifically, the second elastic member 227 may apply a restoring force to the second link module and the finger tip 226 in a direction in which a figure formed by the second link module and the finger tip 226 becomes a parallelogram. The second elastic member 227 may be made of a material having elasticity. The second elastic member 227 may include a spring, but the second elastic member 227 is not limited thereto as long as an element thereof has elasticity.

The second link module may include a second-second link 222 which is coupled to the second-first link 221 to be rotatable about the second-second rotation axis A22 and to which the second elastic member 227 is couple. That is, both ends of the second elastic member 227 may be respectively coupled to the second-second link 222 and the finger tip 226. On the basis of a state of FIG. 3, the second-second link 222 may be arranged while extending in the gripping direction D2.

The second link module may include a second-third link 223 of which one side is coupled to the second-second link 222 to be rotatable about a second-fifth rotation axis A25 and the other side is coupled to the finger tip 226 to be rotatable about the second-third rotation axis A23. On the basis of the first state, the second-third link 223 may be arranged at an inclination in the gripping direction D2 relative to the protruding direction D1. As described above, in the first exemplary embodiment of the present disclosure, it is illustrated that the first-fifth link 215 and the second-third link 223 are integrated with each other, but these links may be formed as separate components and move together as a single body.

The second link module may include a second-fourth link 224 coupled to both the second-first link 221 and the second-second link 222 to be rotatable about the second-second rotation axis A22. On the basis of the first state, the second-fourth link 224 may be arranged at an inclination in the gripping direction D2 relative to the protruding direction D1, and the degree of inclination thereof may be equal to the degree of inclination of the second-third link 223.

The second link module may include a second-fifth link 225 of which one side is coupled to the second-fourth link 224 and the other side is coupled to the finger tip 226 to be rotatable about the second-third rotation axis A23. On the basis of a state of FIG. 3, the second-fifth link 225 may be arranged at an inclination in the gripping direction D2 relative to the protruding direction D1, and the degree of inclination thereof may be equal to the degree of inclination of the second-third link 223.

The second-fourth link 224 and the second-fifth link 225 may be coupled to each other by a sliding joint 228 so that a distance between the second-second rotation axis A22 and the second-third rotation axis A23 is changed. An end of the second-fifth link 225 is slidably inserted into a cylinder formed at an end of the second-fourth link 224, and thus, the second-fourth link 224 and the second-fifth link 225 slide relative to each other. Accordingly, the distance between the second-second rotation axis A22 and the second-third rotation axis A23 is changed, but the second-fourth link 224 and the second-fifth link 225 may maintain a shape extending in the same direction.

In the first state, the distance between the second-second rotation axis A22 and the second-fifth rotation axis A25 may be equal to the distance between the second-third rotation axis A23 and the second-fourth rotation axis A24. In a state in which the distance between the second-second rotation axis A22 and the second-third rotation axis A23 is the shortest as in FIG. 3, in the other word, if the distance between two axis A22 and A23 reaches a lower limit of a range that the distance between A22 and A23 may have, the distance between the second-second rotation axis A22 and the second-third rotation axis A23 may be equal to the distance between the second-fourth rotation axis A24 and the second-fifth rotation axis A25. Therefore, in the state in FIG. 3, facing sides of a region surrounded by the second link module and the finger tip 226 have the same length and are parallel to each other, and thus, this region may form a parallelogram. The second elastic member 227 may apply a restoring force to the finger tip 226 and the second link module so that the above-described region forms a parallelogram.

The finger tip 226 may include a tip body 2261 and a gripping member 2262 positioned on a side of the tip body 2261 in the gripping direction D2 in the first state. The gripping member 2262 is formed as a plate shape perpendicular to the gripping direction D2 and may stably support and grip the object S. The tip body 2261 has a triangular shape when viewed as in FIG. 3, and may stably support the gripping member 2262. A sliding accommodation portion 2260 having a shape extending in the protruding direction D1 in the first state may be formed on the tip body 2261. A third link 231 described below is rotatably and slidably coupled to the sliding accommodation portion 2260, and thus, the third link 231 may rotate while moving along the sliding accommodation portion 2260.

The gripping member 2262 may be detachably coupled to the tip body 2261. In this case, there is an advantage in that the gripping member 2262 may be easily attached to or detached from the tip body 2261 according to the size and shape of the object S to be gripped.

The third link structure 23 may include a third link 231 of which one side is coupled to the first-second link to be rotatable about a third-first rotation axis A31 and the other side is rotatably coupled to the sliding accommodation portion 2260 of the finger tip 226 to be rotatable about a third-second rotation axis A32. That is, the other side of the third link 231 may move in the sliding accommodation portion 2260 in the protruding direction D1 while rotating.

The third link 231 may have a bent middle portion. Therefore, a third-first link 2311 adjacent to one side of the third link 231 and a third-second link 2312 adjacent to the other side of the third link 231 may extend in different directions and be coupled to each other at the middle portion. A straight line connecting the third-first rotation axis A31 to the third-second rotation axis A32 may be arranged at an inclination in the gripping direction D2 relative to the protruding direction D1. In the first state, the third-first link 2311 may be arranged at an inclination in the gripping direction D2 relative to the protruding direction D1. In the first state, the third-second link 2312 may be arranged while extending in the protruding direction D1.

FIG. 8 is a view showing that the finger unit 20 and the link structures are superposed on each other in a state in which the finger unit 20 according to the first exemplary embodiment of the present disclosure is pressed and the finger tip 226 moves closer to the base unit 10 in a direction opposite to the protruding direction D1.

The state shown in FIG. 8 is referred to as a second state. In the second state, the finger unit 20 is further pressed in the protruding direction D1 in the first state in which the gripping member 2262 is in contact with the ground G, and thus, the height of the finger unit 20 is reduced by h1. While being converted from the first state to the second state, the third link 231 moves along the sliding accommodation portion 2260 in the protruding direction D1, and links included in the first link module and the second link structure 22 rotate. However, the finger tip 226 does not rotate and comes closer to the base unit 10. That is, in the second state, the gripping member 2262 maintains a state perpendicular to the gripping direction D2, and thus, the finger unit 20 easily grips a regularly shaped object S. The sliding accommodation portion 2260 may be a hole passing through the finger tip 226 and also may include a recess formed by denting the finger tip 226.

FIG. 9 is a view showing that the finger unit 20 and the link structures are superposed on each other in a state in which the finger unit 20 of FIG. 8 is further pressed to rotate the finger tip 226.

The state shown in FIG. 9 is referred to as a third state. In the third state, the finger unit 20 in the second state is further pressed in the protruding direction D1, and thus, the height of the finger unit 20 is reduced by h2 greater than h1 from the first state. In the second state, the third link 231 has already moved along the sliding accommodation portion 2260 to a position at which the third link 231 may no longer move in the protruding direction D1. Accordingly, while being converted from the second state to the third state, the length of the link formed by the second-fourth link 224 and the second-fifth link 225 increases, and the finger tip 226 is rotated to be oriented in a direction opposite to the protruding direction D1. Therefore, the gripping member 2262 and the tip body 2261 may come into contact with the ground G. In the third state, the gripping member 2262 may be perpendicular to a direction that is inclined in the gripping direction D2 relative to the direction opposite to the protruding direction D1.

FIG. 10 is a view showing that the finger unit 20 and the link structures are superposed on each other in a state in which the finger unit 20 of FIG. 9 is further pressed to further rotate the finger tip 226. FIG. 11 is a view illustrating a state in which the gripper 1 including the finger units 20 of FIG. 10 grips the object S.

The state shown in FIG. 10 is referred to as a fourth state. In the fourth state, the finger unit 20 in the third state is further pressed in the protruding direction D1, and thus, the height of the finger unit 20 is reduced by h3 greater than h2 from the first state. While being converted from the third state to the fourth state, the length of the link formed by the second-fourth link 224 and the second-fifth link 225 further increases than in the third state, and the finger tip 226 may rotate to be perpendicular to the direction opposite to the gripping direction D2 relative to the direction opposite to the protruding direction D1. When further rotating, not only the tip body 2261, but also a portion in which the first-second link and the first-sixth link meet each other may come into contact with the ground G. However, the gripping member 2262 may be separated from the ground G by rotation.

As the state transitions from the first state to the fourth state, the finger tip 226 of the finger unit 20 rotates while sweeping the ground G. Accordingly, an irregularly shaped object S placed on a floor may be easily lifted, and the object S may be gripped while the object S is seated on the gripping member 2262 without pressing the object S.

When the base unit 10 moves in the direction opposite to the protruding direction D1, the finger unit 20 may sequentially return to the first state from the fourth state via the third state and the second state by the first elastic member 217 and the second elastic member 227.

### Second Exemplary Embodiment

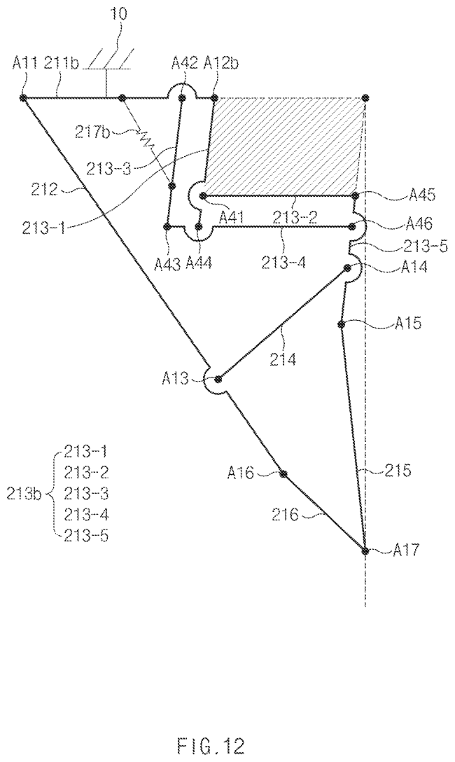

FIG. 12 is a view conceptually showing a first link structure according to a second exemplary embodiment of the present disclosure.

The second and third exemplary embodiments are different from the first exemplary embodiment only in terms of some configurations of the first link structure. Accordingly, the second and third exemplary embodiments are described with a focus on differences, and other contents are replaced with the contents described in the first exemplary embodiment.

A first-third link 213b according to the second exemplary embodiment may include: a first-third-first link member 213-1 coupled to a first-first link 211b to be rotatable about a first-second rotation axis A12b; a first-third-second link member 213-2 coupled to the first-third-first link member 213-1 to be rotatable about a fourth-first rotation axis A41; a first-third-third link member 213-3 coupled to the first-first link 211b to be rotatable about a fourth-second rotation axis A42; a first-third-fourth link member 213-4 which is coupled to the first-third-third link member 213-3 to be rotatable about a fourth-third rotation axis A43 and is coupled to the first-third-first link member 213-1 to be rotatable about a fourth-fourth rotation axis A44; and a first-third-fifth link member 213-5 which is coupled to the first-third-second link member 213-2 to be rotatable about a fourth-fifth rotation axis A45 and is coupled to the first-third-fourth link member 213-4 to be rotatable about a fourth-sixth rotation axis A46.

The first-third-first link member 213-1 and the first-third-third link member 213-3 may be parallel to each other, and the first-third-second link member 213-2 and the first-third-fourth link member 213-4 may be parallel to each other.

The distance between a first-first rotation axis A11 and the fourth-second rotation axis A42 may be less than the distance between the first-first rotation axis A11 and the first-second rotation axis A12b, and the distance between a first-fourth rotation axis A14 and the fourth-sixth rotation axis A46 may be less than the distance between the first-fourth rotation axis A14 and the fourth-fifth rotation axis A45.

Both ends of a first elastic member 217b may be respectively coupled to the first-first link 211b and the first-third-third link member 213-3.

As illustrated in FIGS. 4 and 12, the first link structure according to the second exemplary embodiment may reduce a space occupied by the first-third link compared to the first link structure 21 according to the first exemplary embodiment (see the shaded region in FIG. 12). Accordingly, the size of the gripper may be reduced more effectively.

### Third Exemplary Embodiment

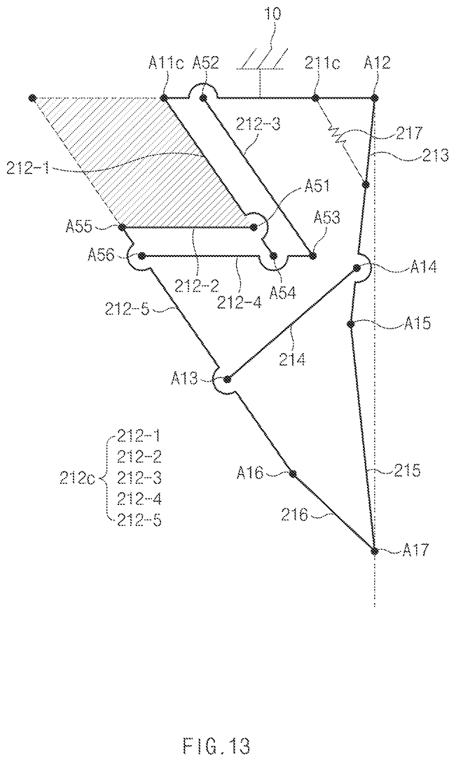

FIG. 13 is a view conceptually showing a first link structure according to a third exemplary embodiment of the present disclosure.

A first-second link 212c according to the third exemplary embodiment may further include: a first-second-first link member 212-1 coupled to a first-first link 211c to be rotatable about the first-first rotation axis A11c; a first-second-second link member 212-2 coupled to the first-second-first link member 212-1 to be rotatable about a fifth-first rotation axis A51; a first-second-third link member 212-3 coupled to the first-first link 212c to be rotatable about a fifth-second rotation axis A52; a first-second-fourth link member 212-4 which is coupled to the first-second-third link member 212-3 to be rotatable about a fifth-third rotation axis A53 and is coupled to the first-second-first link member 212-1 to be rotatable about a fifth-fourth rotation axis A54; and a first-second-fifth link member 212-5 which is coupled to the first-second-second link member 212-2 to be rotatable about a fifth-fifth rotation axis A55 and is coupled to the first-second-fourth link member 212-4 to be rotatable about a fifth-sixth rotation axis A56.

The first-second-first link member 212-1 and the first-second-third link member 212-3 may be parallel to each other, and the first-second-second link member 212-2 and the first-second-fourth link member 212-4 may be parallel to each other.

The distance between a first-second rotation axis A12 and the fifth-second rotation axis A52 may be less than the distance between the first-second rotation axis A12 and the first-first rotation axis A11c, and the distance between a first-third rotation axis A13 and the fifth-sixth rotation axis A56 may be less than the distance between the first-third rotation axis A13 and the fifth-fifth rotation axis A55.

As illustrated in FIGS. 4 and 13, the first link structure according to the third exemplary embodiment may reduce a space occupied by the first-second link compared to the first link structure 21 according to the first exemplary embodiment (see the shaded region in FIG. 13). Accordingly, the size of the gripper may be reduced more effectively.

The rotation axes described herein may be formed parallel to each other.

Accordingly, various objects may be gripped in various environments by the gripper that has the finger unit having the adaptive mechanism.

Even though all the components constituting an exemplary embodiment of the present disclosure have been described as being combined as one body or operating in combination, the present disclosure is not necessarily limited to the exemplary embodiment. That is, within the scope of the objectives of the present disclosure, all the components may be selectively combined into one or more and then operated. Also, terms such as “include,” “constitute,” or “have” described above may mean that the corresponding components may be included unless explicitly described to the contrary, and thus should be construed as further including other components rather than excluding other components. Unless otherwise defined, all terms including technical or scientific terms have the same meanings as those generally understood by a person skilled in the art to which the present disclosure pertains. Terms used generally such as terms defined in dictionaries should be interpreted as having the same meaning as in an associated technical context, and should not be understood abnormally or as having an excessively formal meaning unless defined apparently in the present disclosure.

The technical ideas of the present disclosure have been described merely for illustrative purposes, and those skilled in the art appreciate that various changes and modifications are possible without departing from the essential features of the present disclosure. Therefore, the exemplary embodiments of the present disclosure are to be considered illustrative and not restrictive, and the technical idea of the present disclosure is not limited to the foregoing embodiments. The protective scope of the present disclosure is defined by the appended claims, and all technical ideas within their equivalents should be interpreted as being included in the scope of the present disclosure.

1. A gripper comprising:
a base unit; and
a plurality of finger units coupled to a protruding direction-side of the base unit;
wherein each of the plurality of finger units comprises a first link structure coupled to the base unit, a second link structure rotatably coupled to the first link structure, and a third link structure rotatably coupled to both the first link structure and the second link structure;
wherein the second link structure comprises a finger tip;
wherein when the finger unit is pressed in a protrusion direction, the finger tip is brought closer to the base unit in the protrusion direction by the first link structure; and
wherein when the finger unit is further pressed in the protrusion direction, and the finger tip is rotated to be oriented in a direction opposite to the protruding direction in a state in which the finger tip is oriented in a gripping direction that is a direction perpendicular to the protruding direction.

2. The gripper of claim 1, wherein each of the first link structures comprises:
a first-first link coupled and fixed to one side of the base unit;
a first link module coupled to the first-first link and configured to be rotatable about each of a first-first rotation axis and a first-second rotation axis; and
a first elastic member having a first side coupled to the first-first link and a second side coupled to the first link module;
wherein the first elastic member presses the first link module in a direction in which a link tip of the first link structure coupled to the finger tip moves away from the first-first link.

3. The gripper of claim 2, wherein the first link module comprises:
a first-second link coupled to the first-first link and configured to be rotatable about the first-first rotation axis; and
a first-third link coupled to the first-first link and configured to be rotatable about the first-second rotation axis;
wherein the second side of the first elastic member is coupled to the first-third link.

4. The gripper of claim 3, wherein the first link module further comprises:
a first-fourth link which is coupled to the first-second link and configured to be rotatable about a first-third rotation axis, and is coupled to the first-third link and configured to be rotatable about a first-fourth rotation axis; and
a first-fifth link coupled to the first-third link and configured to be rotatable about a first-fifth rotation axis;
wherein a distance between the first-second rotation axis and the first-fourth rotation axis is less than a distance between the first-second rotation axis and the first-fifth rotation axis.

5. The gripper of claim 4, wherein the first link module further comprises a first-sixth link which is coupled to the first-second link ad configured to be rotatable about a first-sixth rotation axis, and is coupled to the first-fifth link and configured to be rotatable about a first-seventh rotation axis; and
the first-seventh rotation axis is formed at the link tip.

6. The gripper of claim 5, wherein a distance between the first-first rotation axis and the first-third rotation axis is less than a distance between the first-first rotation axis and the first-sixth rotation axis.

7. The gripper of claim 5, wherein the first link structure has a shape in which a region, in which the first-third link and the first-fifth link meet each other, is recessed toward the first-fourth link from a virtual line that connects the first-second rotation axis to the first-seventh rotation axis.

8. The gripper of claim 5, wherein the first-third link comprises:
a first-third-first link member coupled to the first-first link and configured to be rotatable about the first-second rotation axis;
a first-third-second link member coupled to the first-third-first link member and configured to be rotatable about a fourth-first rotation axis;
a first-third-third link member coupled to the first-first link and configured to be rotatable about a fourth-second rotation axis;
a first-third-fourth link member which is coupled to the first-third-third link member and configured to be rotatable about a fourth-third rotation axis, and is coupled to the first-third-first link member and configured to be rotatable about a fourth-fourth rotation axis; and
a first-third-fifth link member which is coupled to the first-third-second link member is configured to be rotatable about a fourth-fifth rotation axis, and is coupled to the first-third-fourth link member and configured to be rotatable about a fourth-sixth rotation axis.

9. The gripper of claim 8, wherein the first-third-first link member and the first-third-third link member are parallel to each other; and
wherein the first-third-second link member and the first-third-fourth link member are parallel to each other.

10. The gripper of claim 8, wherein the second side of the first elastic member is coupled to the first-third-third link member.

11. The gripper of claim 3, wherein the third link structure comprises a third link of which one side is coupled to the first-second link and configured to be rotatable about a third-first rotation axis, and an other side is rotatably coupled to the finger tip; and
a sliding accommodation portion extending in the protrusion direction is formed in the finger tip so that the other side of the third link is coupled to the sliding accommodation portion, and moves in the protrusion direction while rotating.

12. The gripper of claim 11, wherein the third link has a bent middle portion.

13. The gripper of claim 3, wherein the first-second link further comprises:
a first-second-first link member coupled to the first-first link and configured to be rotatable about the first-first rotation axis;
a first-second-second link member coupled to the first-second-first link member and configured to be rotatable about a fifth-first rotation axis;
a first-second-third link member coupled to the first-first link and configured to be rotatable about a fifth-second rotation axis;
a first-second-fourth link member which is coupled to the first-second-third link member is configured to be rotatable about a fifth-third rotation axis, and is coupled to the first-second-first link member and configured to be rotatable about a fifth-fourth rotation axis; and
a first-second-fifth link member which is coupled to the first-second-second link member is configured to be rotatable about a fifth-fifth rotation axis, and is coupled to the first-second-fourth link member and configured to be rotatable about a fifth-sixth rotation axis.

14. The gripper of claim 13, wherein the first-second-first link member and the first-second-third link member are parallel to each other; and
wherein the first-second-second link member and the first-second-fourth link member are parallel to each other.

15. The gripper of claim 2, wherein the second link structure further comprises:
a second-first link coupled to the first-first link and configured to be rotatable about a second-first rotation axis;
a second link module which is coupled to the second-first link is configured to be rotatable about a second-second rotation axis, and is coupled to the finger tip and configured to be rotatable about both a second-third rotation axis and a second-fourth rotation axis; and
a second elastic member of which one side is coupled to the second link module and an other side is coupled to the finger tip.

16. The gripper of claim 15, wherein the second link module comprises:
a second-second link which is coupled to the second-first link and configured to be rotatable about the second-second rotation axis, and to which the second elastic member is coupled;
a second-third link of which one side is coupled to the second-second link and configured to be rotatable about a second-fifth rotation axis, and an other side is coupled to the finger tip and configured to be rotatable about the second-third rotation axis;
a second-fourth link coupled to both the second-first link and the second-second link and configured to be rotatable about the second-second rotation axis; and
a second-fifth link of which one side is coupled to the second-fourth link and an other side is coupled to the finger tip and configured to be rotatable about the second-third rotation axis;
wherein the second-fourth link and the second-fifth link are coupled to each other by a sliding joint so that a distance between the second-second rotation axis and the second-third rotation axis is changed.

17. The gripper of claim 16, wherein a distance between the second-second rotation axis and the second-fifth rotation axis is equal to a distance between the second-third rotation axis and the second-fourth rotation axis; and
when a distance between the second-second rotation axis and the second-third rotation axis reaches a lower limit, the distance between the second-second rotation axis and the second-third rotation axis is equal to a distance between the second-fourth rotation axis and the second-fifth rotation axis.

18. The gripper of claim 17, wherein the second elastic member applies a restoring force to both the finger tip and the second link module so that a region surrounded by the second link module and the finger tip forms a parallelogram.

19. The gripper of claim 1, wherein points, at which a link tip of the first link structure rotatably coupled to the finger tip is located, are arranged on a straight line.
